(19) United States
(12) Patent Application Publication
(10) Pub. No.: US 2014/0322591 A1
(43) Pub. Date: Oct. 30, 2014

(54) NON-AQUEOUS ELECTROLYTE SECONDARY BATTERY

(71) Applicant: PANASONIC CORPORATION, Osaka (JP)

(72) Inventors: Taisuke Yamamoto, Nara (JP); Tatsuki Hiraoka, Hyogo (JP); Keiichi Takahashi, Hyogo (JP); Yoshiyuki Muraoka, Osaka (JP)

(21) Appl. No.: 14/362,009

(22) PCT Filed: Dec. 27, 2012
(86) PCT No.: PCT/JP2012/008383

§ 371 Date: May 30, 2014

(30) Foreign Application Priority Data
Dec. 27, 2011 (JP) 2011-285634

(51) Int. Cl. H01M 4/36

(52) U.S. Cl. CPC H01M 4/364; H01M 2004/027
USPC 429/164; 429/163

(57) ABSTRACT

Disclosed is a non-aqueous electrolyte secondary battery including a positive electrode, a negative electrode, a non-aqueous electrolyte, and a battery case containing them. The negative electrode includes SiOₓ where 0.5<x<1.5, and a carbon material. The non-aqueous electrolyte includes a halogenated cyclic carbonate. A ratio of mass b of the halogenated cyclic carbonate included in the non-aqueous electrolyte to mass a of the SiOₓ included in the negative electrode satisfies 0.001<b/a<3. A percentage of the SiOₓ to the total of the SiOₓ and the carbon material included in the negative electrode is preferably more than or equal to 3 mass % and less than 40 mass %.

### TECHNICAL FIELD

The present invention relates to a non-aqueous electrolyte secondary battery containing, as negative electrode active material, a silicon oxide and a carbon material.

### BACKGROUND ART

Non-aqueous electrolyte secondary batteries have a high voltage and a high capacity, and great expectation has been placed on their development. Carbon materials capable of absorbing and releasing lithium ions are widely used as negative electrode active material for non-aqueous electrolyte secondary batteries. However, as the demand for a higher capacity grows with increasing miniaturization and weight reduction of portable electronic devices, an increasing attention is paid to alloy-type active materials having a higher capacity than carbon materials. Alloy-type active materials are materials containing an element capable of alloying with lithium. Among them, silicon oxides are considered as promising.

However, silicon oxides greatly expand and contract in association with charge and discharge, and therefore, the particles thereof tend to crumble into smaller particles. Surfaces created by this crumbling react with non-aqueous electrolyte, causing gas generation. For this reason, a battery including a silicon oxide in the negative electrode, when subjected to repetitive charge and discharge cycles, tends to show a drop in battery capacity.

Patent Literature 1 proposes that in a non-aqueous electrolyte secondary battery provided with a negative electrode containing a silicon oxide as a principal component, a halogenated cyclic carbonate be added to the non-aqueous electrolyte in order to improve the cycle characteristics of the battery.

### CITATION LIST

### Patent Literature

[PTL 1] Japanese Laid-Open Patent Publication No. 2008-210618

### SUMMARY OF INVENTION

### Technical Problem

However, in some cases, the addition of a halogenated cyclic carbonate to the non-aqueous electrolyte results in little improvement in cycle characteristics, or, contrary to the intention, increases the amount of gas generated at high temperatures, resulting in deterioration in cycle characteristics. The present inventors have studied on the cause therefore, and found that the gas generation occurs mainly due to the halogenated cyclic carbonate being in excess over the amount of silicon oxide.

The amount of non-aqueous electrolyte contained in a battery greatly differs depending on the battery shape and other factors. Accordingly, even though the additive concentration in non-aqueous electrolyte is unchanged, the amount of additive introduced into a battery will vary greatly. For example, in a cylindrical battery, in view of increasing its volumetric energy density, an electrode group including a positive electrode, a negative electrode, and a separator is designed to occupy a large proportion in the battery case; while the proportion of the non-aqueous electrolyte is small. Conversely, in a coin battery or a large-size battery, the non-aqueous electrolyte is used abundantly in many cases. Therefore, even though the additive concentration in the non-aqueous electrolyte is unchanged, the amount of additive in the battery would be deficient or in excess.

The halogenated cyclic carbonate is considered to form a surface film containing LiF on the negative electrode active material, thereby to inhibit the reaction between the non-aqueous electrolyte and the active material. However, when the halogenated cyclic carbonate is used in an amount considered necessary in consideration of the magnitude of expansion and contraction of the silicon oxide and the crumbling thereof into smaller particles, the halogenated cyclic carbonate is likely to be in excess. The excess halogenated cyclic carbonate is readily decomposed in a high temperature environment, causing gas generation.

### Solution to Problem

In view of the above, the present invention proposes a non-aqueous electrolyte secondary battery including: a positive electrode; a negative electrode; a non-aqueous electrolyte; and a battery case containing the positive electrode, the negative electrode, and the non-aqueous electrolyte. The negative electrode includes SiOₓ where 0.5<x<1.5, and a carbon material. The non-aqueous electrolyte includes a halogenated cyclic carbonate. A ratio of mass b of the halogenated cyclic carbonate included in the non-aqueous electrolyte to mass a of the SiOₓ included in the negative electrode satisfies 0.001<b/a<3.

### Advantageous Effects of Invention

In the present invention, since the ratio of mass b of the halogenated cyclic carbonate to mass a of the SiOₓ included in the negative electrode is controlled within the range of 0.001<b/a<3, a surface film derived from the halogenated cyclic carbonate can be sufficiently formed on the negative electrode active material while the halogenated cyclic carbonate can be kept from being deficient or in excess relative to the silicon oxide, and gas generation can be suppressed. Therefore, the cycle characteristics can be effectively improved.

While the novel features of the invention are set forth particularly in the appended claims, the invention, both as to organization and content, will be better understood and appreciated, along with other objects and features thereof, from the following detailed description taken in conjunction with the drawings.

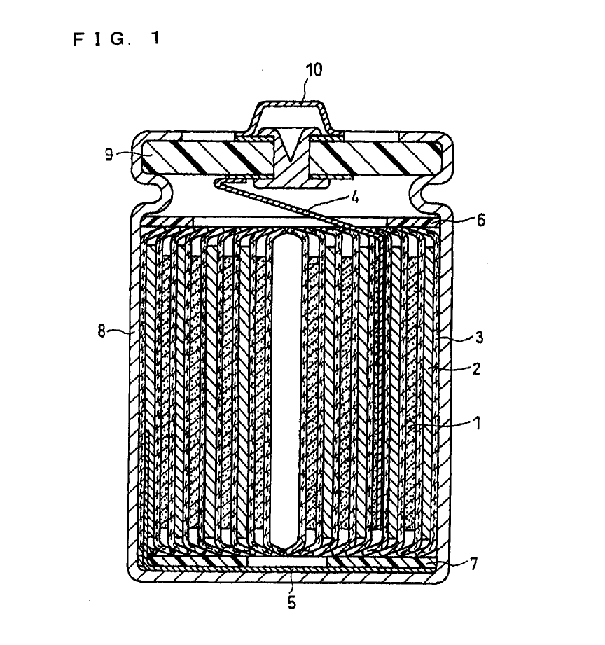

### BRIEF DESCRIPTION OF DRAWING

[FIG. 1] A longitudinal cross-sectional view of a non-aqueous electrolyte secondary battery according to one embodiment of the present invention

### DESCRIPTION OF EMBODIMENTS

A non-aqueous electrolyte secondary battery of the present invention includes a positive electrode, a negative electrode, a non-aqueous electrolyte, and a battery case containing them. The negative electrode includes SiOₓ having 0.5<x<1.5, and a carbon material. The non-aqueous electrolyte includes a halogenated cyclic carbonate. The ratio of mass b of the halogenated cyclic carbonate included in the non-aqueous electrolyte to mass a of the SiOₓ included in the negative electrode satisfies 0.001<b/a<3.

When the b/a ratio is less than or equal to 0.001, the halogenated cyclic carbonate to act on the silicon oxide is insufficient, resulting in little improvement in cycle characteristics. On the other hand, when the b/a ratio is more than or equal to 3, the amount of gas derived from the halogenated cyclic carbonate generated in a high temperature environment will be increased, reducing the reliability.

In view of more effectively improving the cycle characteristics, a preferable lower limit of the range of the b/a ratio may be 0.01. In view of further reducing the amount of gas to be generated, a preferable upper limit of the range of the b/a ratio may be 1. These upper and lower limits can be combined in any combination.

Here, the reason why the mass ratio of the halogenated cyclic carbonate to the silicon oxide is controlled, rather than to a total of the silicon oxide and the carbon material, is as follows. The silicon oxide has a higher expansion rate than the carbon material, and when expands, readily causes cracks in the active material. Cracks in the active material create new surfaces. The new surfaces come in contact with the non-aqueous electrolyte, causing a side reaction, to consume the non-aqueous electrolyte. In that way, the additive is consumed mainly by the silicon oxide, and for this reason, the amount of the halogenated cyclic carbonate relative to the silicon oxide is controlled so that the halogenated cyclic carbonate can effectively exert its function.

The silicon oxide SiOₓ where 0.5<x<1.5 and the carbon material may be in any form. However, the silicon oxide is poor in electrical conductivity. To ensure the output characteristics, it is necessary to ensure the contact with the carbon material having electrical conductivity, and form an electrically conductive network within the active material layer. Therefore, it is necessary to pack the silicon oxide and the carbon material in a mixed or composite state in the negative electrode active material layer.

The mixed or composite state includes, but not limited to, (i) a state in which the silicon oxide is packed in the gaps formed by the carbon material, and (ii) a state in which the carbon material and the silicon oxide are granulated into composite particles. The surface of the silicon oxide may be coated in advance with, for example, 1 to 10 mass % of the carbon material, relative to the silicon oxide.

The state (i) above can be more easily achieved by, for example, setting the percentage of the SiOₓ to the total of the SiOₓ and the carbon material included in the negative electrode to less than 40 mass %, and preferably less than 30 mass %, and then, for example, setting the average particle size of the SiOₓ particles to be smaller than that of the carbon material. In this case, the carbon material is preferably a particulate material, such as graphite, graphitizable carbon, and non-graphitizable carbon. The relationship between average particle size D_{SiO} of the SiOₓ particles and average particle size D_{c} of the carbon material preferably satisfies 0.5≦D_{c}/D_{SiO}≦10 (e.g., 1<D_{c}/D_{SiO}≦10), and more preferably satisfies 0.5≦D_{c}/D_{SiO}≦5 (e.g., 2≦D_{c}/D_{SiO}≦5). The average particle size of the carbon material is preferably more than or equal to 1 μm, and more preferably, more than or equal to 5 μm. As described above, by designing the average particle sizes of the SiOₓ and the carbon material each being a particulate material, the detriment due to expansion and contraction of the silicon oxide can be more effectively eliminated, and the cycle characteristics can be easily improved even though the b/a ratio is small.

The state (ii) above is, for example, a state in which at least part of the SiOₓ and at least part of the carbon material are aggregated, forming composite particles. The composite particles can be obtained, for example, by stirring SiOₓ powder and carbon material in a mixer such as a ball mill in which shear force can be applied or in a fluidized bed, or by spray-drying a slurry containing SiOₓ powder and carbon material. Examples of the carbon material before formed into a composite with SiOₓ include: particulate materials of graphite, graphitizable carbon, non-graphitizable carbon, and amorphous carbon; and carbon fibers.

In the case of spray-drying, or using a fluidized bed, a composite of SiOₓ powder and a precursor of carbon material may be formed first, and then heated to carbonize or graphitize the precursor. Examples of the precursor include pitch and tar.

The percentage of the SiOₓ to the total of the SiOₓ and the carbon material included in the negative electrode is preferably more than or equal to 3 mass % and less than 40 mass %. An increase in the percentage of the silicon oxide increases the influence of the crumbling thereof into smaller particles due to expansion and contraction. For this reason, even with the halogenated cyclic carbonate, it tends to become gradually difficult to suppress the deterioration in cycle characteristics and the gas generation. By setting the percentage of the SiOₓ to less than 40 mass %, the influence of the crumbling of the silicon oxide can be desirably reduced, and an appropriate amount of halogenated cyclic carbonate can be reductively decomposed. Consequently, the effect of cycle characteristics improvement and the effect of gas generation suppression can be synergistically enhanced. Therefore, even though the b/a ratio is less than 3, or as small as less than 2, favorable cycle characteristics can be obtained.

In view of achieving a higher capacity, a preferable lower limit of the percentage of the SiOₓ to the total of the SiOₓ and the carbon material may be 3 mass %, 5 mass %, 8 mass %, or 10 mass %. In view of further reducing the influence of the crumbling of the silicon oxide, a preferable upper limit of the percentage of the SiOₓ may be 30 mass %, 25 mass %, 20 mass %, 15 mass %, or 10 mass %. These upper and lower limits can be combined in any combination.

### [Silicon Oxide]

The SiOₓ where 0.5<x<1.5 is preferably fine-crystalline or amorphous. By using a silicon oxide being fine-crystalline or amorphous, the crumbling of the silicon oxide can be easily suppressed. Moreover, by setting the molar ratio: x of oxygen to silicon element to 0.5<x<1.5, a high capacity can be ensured, and at the same time, the crumbling of the silicon oxide can be easily suppressed. The silicon oxide as mentioned above is considered to be formed of an amorphous SiO₂ matrix and fine-crystalline or amorphous silicon dispersed in the matrix.

The molar ratio: x of oxygen to silicon element in the silicon oxide preferably satisfy 0.5<x<1.5. By using such a silicon oxide, the expansion and contraction thereof can be more easily suppressed, and the cycle characteristics can be more effectively improved.

The silicon oxide included in the negative electrode active material layer is preferably a particulate material having an average particle size of 0.2 to 20 μm, and more preferably of 1 to 10 μm. When the silicon oxide has a particle size in such a range, the crumbling thereof can be easily suppressed, and because the specific surface area is adequate, the active material utilization rate and the rate characteristics can be easily ensured. In addition, since the silicon oxide has an adequately small specific surface area, the gas generation can be more effectively suppressed.

### [Carbon Material]

The carbon material may be any material that, in the negative electrode active material layer, serves as either an active material (a material capable of absorbing and releasing lithium ions) or an electrically conductive material, or both of them. Examples of the carbon material include artificial graphite, natural graphite, non-graphitizable carbon, graphitizable carbon, amorphous carbon, and carbon fibers. These may be used singly or in combination of two or more.

In view of achieving a higher capacity, the carbon material included in the negative electrode active material layer preferably includes a particulate material having an average particle size of 1 to 30 μm, preferably of 5 to 25 m, 5 to 20 m, or 10 to 20 μm. The particulate material of carbon material is preferably at least one selected from the group consisting of graphite, non-graphitizable carbon, and graphitizable carbon, and more preferably, includes at least graphite. Such a carbon material can easily provide a higher capacity, and is advantageous in increasing the packing density of active material in the active material layer.

The “graphite” herein collectively refers to carbon materials having a portion with a graphite structure. Accordingly, the graphite includes natural graphite, artificial graphite, and graphitized mesophase carbon particles, and others.

Next, an exemplary method of producing a negative electrode including composite particles of a silicon oxide and a carbon material is described.

First, SiOₓ particles, together with a carbon material such as graphite, non-graphitizable carbon, or graphitizable carbon, are stirred in a mixer such as a ball mill, or oscillated in a fluidized bed, thereby to prepare composite particles of the SiOₓ particles and carbon material. To the resultant composite particles, a carbon material such as graphite, non-graphitizable carbon, or graphitizable carbon may be further added.

Next, a surface film of carbon material is formed on the SiOₓ particles in the composite particles. Specifically, the composite particles are placed in a hydrocarbon gas atmosphere, and heated, to allow a carbon material produced through pyrolysis of the hydrocarbon gas to deposit on the particle surfaces. In that way, a surface film of electrically conductive carbon material can be formed on the SiOₓ particles. At this time, the surface film of conductive carbon material can be formed also on the graphite, non-graphitizable carbon, graphitizable carbon, and the like.

Subsequently, the composite particles and, if necessary, an additional carbon material, together with a binder, are mixed with a liquid component, thereby to prepare a slurry. The slurry is applied onto a current collector sheet such as metal foil, and the applied film is dried and pressed. A negative electrode active material layer is thus obtained.

### [Non-Aqueous Electrolyte]

The non-aqueous electrolyte is preferably a non-aqueous solvent in which a lithium salt is dissolved. To the non-aqueous electrolyte, a halogenated cyclic carbonate is added so as to satisfy the above b/a ratio. Preferable examples of the halogenated cyclic carbonate are compounds having a structure in which at least one hydrogen atom of ethylene carbonate or propylene carbonate is substituted by fluorine atom.

In view of the solubility in the non-aqueous electrolyte and the film-forming ability, preferred among them is at least one selected from the group consisting of monofluoroethylene carbonate and difluoroethylene carbonate.

Examples of the non-aqueous solvent include: cyclic carbonates, such as ethylene carbonate (EC), propylene carbonate (PC), butylene carbonate, and vinylene carbonate; chain carbonates, such as dimethyl carbonate (DMC), diethyl carbonate (DEC), and ethyl methyl carbonate (EMC); and cyclic carboxylic acid esters, such as γ-butyrolactone and γ-valerolactone. Other examples of the non-aqueous solvent include: 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, sulfolane, 3-methyl-2-oxazolidinone, diethyl ether, and 1,3-propane sultone. These may be used singly or in combination of two or more. The non-aqueous solvent preferably contains at least one selected from the group consisting of the above chain carbonates and cyclic carbonates in an amount of 60 vol % or more, or 70 vol % or more, and preferably contains at least one chain carbonate and at least one cyclic carbonate in combination.

The non-aqueous solvent preferably includes at least one selected from the group consisting of EC and PC. A surface film derived from a halogenated cyclic carbonate alone tends to be comparatively loosely packed, but when hybridized with a surface film derived from EC or PC, it tends to be densely packed and highly heat resistant. For example, the non-aqueous electrolyte preferably contains 1 to 70 vol % of EC or PC.

Examples of the lithium salt includes LiPF₆, LiBF₄, LiClO₄, LiCF₃SO₃, LiCF₃CO₂, LiN(CF₃SO₂)₂ and LiN(C₃F₅SO₂)₂. These may be used singly or in combination of two or more. The lithium salt concentration in the non-aqueous electrolyte is, for example, 0.5 to 2 mol/L.

The non-aqueous electrolyte may contain, in addition to the above, an unsaturated cyclic carbonate. Examples of the unsaturated cyclic carbonate include vinylene carbonate, vinylethylene carbonate, and divinylethylene carbonate.

The amount of non-aqueous electrolyte contained in the battery greatly depends on the shape and others of the battery. For example, in a cylindrical battery in which the battery case is a cylindrical metal can, the amount of non-aqueous electrolyte contained in the battery is preferably 1.0 to 2.5 g per Ah of nominal capacity (design capacity) of the cylindrical battery. In this case, the b/a ratio preferably satisfies, for example, 0.1<b/a<2.

In a prismatic battery in which the battery case is a prismatic metal can, or a thin battery in which the battery case is an envelope-type flexible bag, the amount of non-aqueous electrolyte included in the battery is preferably 1.5 to 3.5 g per Ah of nominal capacity (design capacity) of the battery. In this case, the b/a ratio preferably satisfies, for example, 0.15b/a<3.

In the following, one example of the non-aqueous electrolyte secondary battery of the present invention is described with reference to a drawing.

FIG. 1 is a longitudinal cross-sectional view of an exemplary cylindrical non-aqueous electrolyte secondary battery.

The non-aqueous electrolyte secondary battery is a wound battery including a belt-shaped positive electrode 1, a belt-shaped negative electrode 2, a separator 3, a positive electrode lead 4, a negative electrode lead 5, an upper insulating plate 6, a lower insulating plate 7, a battery case 8, a sealing plate 9, a positive terminal 10, and a non-aqueous electrolyte (not shown). The negative electrode 2 has active material layers including the above-described negative electrode active material, and a belt-shaped current collector sheet supporting them on both sides. On both surfaces of the positive electrode 1 or the negative electrode 2, an organic or inorganic porous film (not shown) may be formed. The non-aqueous electrolyte contains a halogenated cyclic carbonate.

The positive electrode 1 and the negative electrode 2 are spirally wound, with the separator 3 interposed therebetween, forming an electrode group. One end of the positive electrode lead 4 is connected to the positive electrode 1, and the other end thereof is connected to the sealing plate 9. The material of the positive electrode lead 4 is, for example, aluminum. One end of the negative electrode lead 5 is connected to the negative electrode 2, and the other end thereof is connected to the bottom of the battery case 8 to serve as a negative terminal. The material of the negative electrode lead 5 is, for example, nickel. The battery case 8 is a bottom-closed cylinder battery can with one end thereof in the longitudinal direction being an opening and the other end thereof being the bottom, and functions as a negative terminal. The upper insulating plate 6 and the lower insulating plate 7 are each a resin member, and vertically sandwich the electrode group therebetween, thereby to electrically insulate the electrode group from the other members. The material of the battery case 8 is, for example, iron. The inner surface of the battery case 8 is nickel-plated. The sealing plate 9 is provided with the positive terminal 10.

### [Negative Electrode]

The belt-shaped negative electrode is composed of a negative electrode current collector sheet and a negative electrode active material layer adhering to both surfaces thereof. The negative electrode active material layer includes a negative electrode active material and a binder as essential components, and can include a thickener and the like as optional components. The negative electrode active material includes a silicon oxide and a carbon material. The negative electrode active material layer is obtained by mixing a negative electrode active material, a binder, and a liquid component serving as a dispersion medium, to prepare a slurry, applying the slurry onto one or both surfaces of the current collector sheet, and drying the applied film. The thickness and density of the applied film are controlled by pressing.

Examples of the binder include fluorocarbon resin, acrylic resin, polyolefin, and particulate rubber. The fluorocarbon resin is exemplified by polytetrafluoroethylene, polyvinylidene fluoride, and vinylidene fluoride-hexafluoropropylene copolymer. The polyolefin is exemplified by polyethylene and polypropylene. The particulate rubber is preferably styrene-butadiene rubber.

### [Positive Electrode]

The belt-shaped positive electrode is composed of a positive electrode current collector sheet and a positive electrode active material layer adhering to both surfaces thereof. The positive electrode active material layer includes a positive electrode active material and a binder as essential components, and can include an electrically conductive material, a thickener, and the like as optional components. The positive electrode active material layer is obtained by mixing a positive electrode active material, a binder, and a liquid component serving as a dispersion medium, to prepare a slurry, applying the slurry onto one or both surfaces of the current collector sheet, and drying the applied film. The thickness and density of the applied film are controlled by pressing.

A preferable example of the positive electrode active material is a lithium-containing transition metal oxide. Examples known as a lithium-containing transition metal oxide are: lithium cobalt oxide (LiCoO₂) having a layered structure, and materials having a crystal structure similar thereto; and lithium manganese oxide (LiMn₂O₄) having a spinel structure, and materials having a crystal structure similar thereto. In the present invention, these known materials can be used without particular limitation. The binder for the positive electrode is not particularly limited, but is preferably fluorocarbon resin. The conductive material for the positive electrode is not particularly limited, and examples thereof include carbon black, carbon nanofiber, and graphite.

The separator is not particularly limited, but is preferably a microporous film or nonwoven fabric made of polyolefin. The microporous film is a resin sheet produced through uniaxial stretching or biaxial stretching, and has a thickness of, for example, 5 to 30 μm, and preferably, 10 to 20 μm.

In the following, the present invention is specifically described by way of Examples, but is not limited to these Examples.

### EXAMPLE 1

### (i) Negative Electrode

SiOₓ particles whose surfaces are coated with carbon (x=1, average particle size: 5 μm, carbon coating amount: 5 mass %) and graphite particles (average particle size: 20 μm) were mixed such that the percentage of the SiO to the total of the two became the value shown in Table 1, thereby to prepare a negative electrode active material. Next, 100 parts by mass of the negative electrode active material, 1 part by mass of carboxymethyl cellulose serving as a thickener, 1 part by mass of styrene-butadiene rubber serving as a binder, and an appropriate amount of pure water were mixed in a mixer, thereby to prepare a negative electrode material mixture slurry. The slurry was applied onto both surfaces of a current collector sheet of an 8-μm-thick electrolytic copper foil, followed by drying and pressing, thereby to produce a belt-shaped negative electrode.

The amount of negative electrode material mixture slurry to be applied was determined such that a charge capacity calculated from the negative electrode theoretical capacity (a negative electrode charge capacity) and a charge capacity calculated from the positive electrode theoretical capacity (a positive electrode charge capacity) satisfy the relational formula:

(Positive electrode charge capacity)/(Negative electrode charge capacity)=1.1

The negative electrode was cut in a size that corresponds to a cylindrical 18650 battery case.

### (ii) Positive Electrode

First, 100 parts by mass of LiNi_{0.8}Co_{0.15}Al_{0.05}O₂, 2 parts by mass of acetylene black, 2 parts by mass of polyvinylidene fluoride, and an appropriate amount of N-methyl-2-pyrrolidone (NMP) were mixed in a mixer, thereby to prepare a positive electrode material mixture slurry. Next, the slurry was applied onto both surfaces of a current collector sheet of a 15-μm-thick Al foil, followed by drying and pressing, thereby to produce a belt-shaped positive electrode. The positive electrode was cut in a size that corresponds to a cylindrical 18650 battery case. The thickness of the positive electrode was 128 μm. The length of the positive electrode was adjusted as appropriate such that the positive and negative charge capacities satisfied the above relational formula, and the battery design capacity became the value shown in Table 1.

(iii) Electrode Group

The above positive and negative electrodes were wound with a separator of a 16-μm-thick polyethylene microporous film interposed therebetween, to form a spirally-wound electrode group. The electrode group was housed in a cylindrical 18650 battery case, and was subjected to processes including lead-connection. Thereafter, 5 g of non-aqueous electrolyte (1.59 to 1.72 g per Ah of design capacity) was added into the battery case, and the non-aqueous electrolyte was allowed to impregnate the electrode group under vacuum, after which the battery was sealed. A sealing plate used here was one provided with a safety valve configured to be activated when the battery internal pressure reaches an upper limit value, to shut off the current.

### (iv) Non-Aqueous Electrolyte

EC, EMC and DMC were mixed in a volume ratio of EC/EMC/DMC=1/1/8, to which LiPF₆ was added at a concentration of 1.2 mol/L, thereby to prepare a non-aqueous electrolyte. To the prepared non-aqueous electrolyte, a predetermined amount of fluoroethylene carbonate (FEC) was added. The amount of FEC added was adjusted such that the ratio of mass b of FEC contained in 5 g of the above non-aqueous electrolyte to mass a of SiO contained in the above negative electrode became the value shown in Table 1.

TABLE 1

| | Percentage | | | |
|---|---|---|---|---|
| | of SiO | Design | b/a | Capacity |
| Battery | particles (mass %) | capacity (mAh) | ratio | retention rate (%) |
| 10 | 3 | 2900 | 0.00 | 78 |
| 11 | 3 | 2900 | 0.19 | 84 |
| 12 | 3 | 2900 | 0.56 | 85 |
| 13 | 3 | 2900 | 1.87 | 86 |
| 14 | 3 | 2900 | 5.60 | Shut-off |
| 15 | 5 | 3000 | 0.00 | 72 |
| 16 | 5 | 3000 | 0.12 | 78 |
| 17 | 5 | 3000 | 0.60 | 85 |
| 18 | 10 | 3150 | 0.00 | 68 |
| 19 | 10 | 3150 | 0.07 | 72 |
| 20 | 10 | 3150 | 0.35 | 78 |
| 21 | 10 | 3150 | 0.70 | 80 |

Cylindrical batteries 10 to 21 as shown in FIG. 1 were produced through the processes as described above, and subjected to the following evaluation. Here, Batteries 10, 14, 15 and 18 are of Comparative Examples.

### [Evaluation]

### (Cycle Characteristics)

Charge and discharge were repeated in a 45° C. environment under the conditions below.

Constant-current charge: charge current 0.5 C, charge cut-off voltage 4.2 V

Constant-voltage charge: charge voltage value 4.2 V, charge cut-off current 0.05 C

Constant-current discharge: discharge current 1.0 C, discharge cut-off voltage 2.5 V

A ratio of the discharge capacity at the 200^{th} cycle to the discharge capacity at the 1^{st} cycle (a capacity retention rate) was calculated.

Table 1 shows that a preferable range of the b/a ratio is from 0.1 to 2 (more specifically, from 0.12 to 1.87) when the percentage of SiOₓ to the total of SiOₓ and carbon material is 3 to 10 mass %, and a more preferable range of the b/a ratio is from 0.19 to 1.87 when the percentage of SiOₓ is 3 to 5 mass %. “Shut-off” of Battery 14 means that the battery internal pressure was raised due to gas generation, and the safety valve was activated.

### Example 2

Battery 22 was produced in the same manner as Battery 17 of Example 1, except that 1,2-difluoroethylene carbonate (DFEC) was used in place of FEC, and was evaluated similarly to the above. The results are shown in Table 2.

TABLE 2

| | | Capacity retention |
|---|---|---|
| | Halogenated | rate |
| Battery | carbonate | (%) |
| 17 | FEC | 85 |
| 22 | DFEC | 86 |

### Example 3

The positive and negative electrodes were produced in the same manner as in Example 1, except that the thickness of the positive electrode was changed to 121 μm, and each cut in a size that corresponds to an envelope-type battery case having a thickness of 5.2 mm, a width of 34 mm, and a height of 36 mm. The cut positive and negative electrodes were wound into a flat electrode group, and housed in the battery case, thereby to produce pouch-type batteries 23 to 34. Into the battery case, a non-aqueous electrolyte was injected in an amount of 2.5 g per Ah of design capacity.

The non-aqueous electrolyte was prepared by mixing EC and DEC in a volume ratio of EC/DEC=2/8, in which LiPF₆ was dissolved at a concentration of 1.2 mol/L. To the prepared non-aqueous electrolyte, a predetermined amount of fluoroethylene carbonate (FEC) was added. The amount of FEC added was adjusted such that the ratio of mass b of FEC contained in 2.5 g of the above non-aqueous electrolyte to mass a of SiO contained in the above negative electrode became the value shown in Table 3. The capacity retention rate was measured in the same way as above.

An increase in thickness of the battery in a charged state after 300 cycles, relative to the battery in a charged state at the 1^{st} cycle was measured. The results are shown in Table 3.

TABLE 3

| | Percentage of | | Capacity | |
|---|---|---|---|---|
| | SiO particles | | retention rate | Increase in |
| Battery | (mass %) | b/a ratio | (%) | battery thickness (mm) |
| 23 | 3 | 0.00 | 75 | 0.51 |
| 24 | 3 | 0.28 | 82 | 0.54 |
| 25 | 3 | 0.83 | 83 | 0.60 |
| 26 | 3 | 2.77 | 85 | 1.0 |
| 27 | 3 | 8.30 | 78 | 3.2 |
| 28 | 5 | 0.00 | 72 | 0.53 |
| 29 | 5 | 0.05 | 78 | 0.60 |
| 30 | 5 | 0.25 | 80 | 0.66 |
| 31 | 10 | 0.00 | 65 | 0.56 |
| 32 | 10 | 0.03 | 75 | 0.72 |
| 33 | 10 | 0.15 | 78 | 0.80 |
| 34 | 10 | 0.31 | 80 | 1.0 |

Here, Batteries 23, 27, 28 and 31 are of Comparative Examples. Table 3 shows that a preferable range of the b/a ratio is from 0.15 to 3 (more specifically, from 0.15 to 2.77) when the percentage of SiOₓ to the total of SiOₓ and carbon material is 3 to 10 mass %, and a more preferable range of the b/a ratio is from 0.25 to 2.77 when the percentage of SiOₓ is 3 to 5 mass %. In view of suppressing the increase in battery thickness, the b/a ratio is preferably less than 1 (e.g., less than or equal to 0.83).

### INDUSTRIAL APPLICABILITY

The non-aqueous electrolyte secondary battery of the present invention has a high capacity and excellent cycle characteristics, and therefore can be applied as a power source for portable electronic devices, and to other applications such as hybrid vehicles (HEVs), electric vehicles, and household power storage system.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: Positive electrode, 2: Negative electrode, 3: Separator, 4: Positive electrode lead, 5: Negative electrode lead, 6: Upper insulating plate, 7: Lower insulating plate, 8: Battery case, 9: Sealing plate, 10: Positive terminal

1. A non-aqueous electrolyte secondary battery comprising:
a positive electrode; a negative electrode; a non-aqueous electrolyte; and a battery case containing the positive electrode, the negative electrode, and the non-aqueous electrolyte,
the negative electrode including SiOₓ where 0.5<x<1.5, and a carbon material,
the non-aqueous electrolyte including a halogenated cyclic carbonate,
a ratio of mass b of the halogenated cyclic carbonate included in the non-aqueous electrolyte to mass a of the SiOₓ included in the negative electrode satisfying 0.001<b/a<3, and
a percentage of SiOₓ to a total of the SiOₓ and the carbon material included in the negative electrode being more than or equal to 3 mass % and less than 40 mass %.

2. (canceled)

3. The non-aqueous electrolyte secondary battery according to claim 1, wherein a percentage of the SiOₓ to a total of the SiOₓ and the carbon material included in the negative electrode is more than or equal to 3 mass % and less than or equal to 10 mass %.

4. The non-aqueous electrolyte secondary battery according to claim 1, wherein
the SiOₓ has a smaller average particle size than the carbon material, and
the carbon material includes at least one selected from the group consisting of graphite, non-graphitizable carbon, and graphitizable carbon.

5. The non-aqueous electrolyte secondary battery according to claim 1, wherein
the battery case comprises a cylindrical metal can,
the non-aqueous electrolyte is contained in an amount of 1.0 to 2.5 g per Ah of nominal capacity of the non-aqueous electrolyte secondary battery, and
0.1<b/a<2.

6. The non-aqueous electrolyte secondary battery according to claim 1, wherein
the battery case comprises a prismatic metal can or an envelope-type flexible bag,
the non-aqueous electrolyte is contained in an amount of 1.5 to 3.5 g per Ah of nominal capacity of the non-aqueous electrolyte secondary battery, and
0.15<b/a<3.

7. The non-aqueous electrolyte secondary battery according to claim 1, wherein the halogenated cyclic carbonate is at least one selected from the group consisting of monofluoroethylene carbonate and difluoroethylene carbonate.

8. The non-aqueous electrolyte secondary battery according to claim 1, wherein the non-aqueous electrolyte includes at least one selected from the group consisting of ethylene carbonate and propylene carbonate.

9. The non-aqueous electrolyte secondary battery according to claim 1, the SiOₓ comprises particles, said particles having a surface film of carbon material on the surface thereof.
